(19) United States
(12) Patent Application Publication
(10) Pub. No.: US 2015/0078278 A1
(43) Pub. Date: Mar. 19, 2015

(54) HYBRID ARQ INFORMATION TRANSMITTING METHOD AND HYBRID ARQ INFORMATION RECEIVING METHOD

(71) Applicant: Pantech Co., Ltd., Seoul (KR)

(72) Inventors: Dong Hyun Park, Seoul (KR); Sung Jun Yoon, Seoul (KR)

(21) Appl. No.: 14/387,612

(22) PCT Filed: Mar. 5, 2013
(86) PCT No.: PCT/KR2013/001778

§ 371 Date: Sep. 24, 2014

(30) Foreign Application Priority Data
Mar. 26, 2012 (KR) 10-2012-0030784

(51) Int. Cl. H04L 1/18

(52) U.S. Cl. CPC H04L 1/1887; H04L 1/1812
USPC 370/329

(57) ABSTRACT

The present application relates to a method for transmitting and receiving hybrid ARQ information transmitted via a downlink in a wireless communication system. In particular, the method for a transmission point to transmit hybrid automatic repeat request (ARQ) information in a system having multiple transmission points comprises, as technical features, the steps of: transmitting virtual cell identity (ID) information to a terminal; and transmitting, using a resource which has been determined on the basis of the virtual cell ID information, hybrid ARQ information for indicating whether uplink data transmitted from the terminal has been received or not.

### CROSS-REFERENCE TO RELATED APPLICATIONS

This application is the National Stage Entry of International Application PCT/KR2013/001778, filed on Mar. 5, 2013, and claims priority from and the benefit of Korean Patent Application No. 10-2012-0030784, filed on Mar. 26, 2012, both of which are incorporated herein by reference for all purposes as if fully set forth herein.

### BACKGROUND

1. Field

The present invention relates to a method of transmitting and receiving hybrid Automatic Repeat reQuest (ARQ) information transmitted in a downlink in a wireless communication system.

2. Discussion of the Background

When a packet is transmitted and received in a mobile communication system, a receiver needs to report, to a transmitter, whether or not the reception of a packet is successful. When the reception of a packet is successful, the receiver transmits an acknowledgement (ACK) so as to indicate that the transmitter is to transmit a new packet, and when the receiver fails to receive a packet, the receiver transmits a Negative Acknowledgement (NACK) so as to indicate that the transmitter is to retransmit the packet. This operation is referred to as an Automatic Repeat (ARQ). A Hybrid ARQ (HARQ) has been provided by coupling the ARQ operation and a channel coding scheme. Information associated with the HARQ may be transferred through a Physical HARQ Indication Channel (PHICH) set in a control area.

When a plurality of Transmission Points (TPs) and a plurality of User Equipments (UEs) cooperate for communication in a system using an enhanced technology such as Coordinated Multi Point (CoMP), PHICH resources (for example, frequency resources) for UEs may conflict occasionally. To prevent the conflict, the system may need to be restricted, and thus, a system performance may be deteriorated.

As new communication schemes have developed, there have been occasional cases where a control area is not set or resources of a control area are insufficient. For these cases, resources for transmitting control information may be set in a data area through which data is transmitted, and the control information may be transmitted based on the set resources. It is also possible that information associated with the HARQ is transmitted through a control information transmission resource set in the data area.

In this instance, resources for transferring HARQ related information to each UE may conflict. To avoid a conflict, fewer electromagnetic wave resources may be used than actually available electromagnetic wave resources.

### SUMMARY

Therefore, the present invention has been made in view of the above-mentioned problems, and an aspect of the present invention is to provide a method of transmitting and receiving hybrid ARQ information, which prevents a conflict of resources used for hybrid ARQ information transmitted in a downlink in a wireless communication system.

In accordance with an aspect of the present invention, there is provided a method for a Transmission Point (TP) to transmit hybrid Automatic Repeat reQuest (ARQ) information, in a system including a plurality of TPs, the method including: transmitting virtual cell Identity (ID) information set based on a TP to a User Equipment (UE); and transmitting hybrid ARQ information indicating whether uplink data transmitted from the UE is received, using a frequency resource determined based on the virtual cell ID information.

In accordance with another aspect of the present invention, there is provided a method for a User Equipment (UE) to receive hybrid Automatic Repeat reQuest (ARQ) information, in a system including a plurality of Transmission Points (TPs), the method including: receiving virtual cell Identity (ID) information set based on a TP from a TP; transmitting uplink data; and receiving hybrid ARQ information indicating whether the TP receives the uplink data transmitted from the UE, using a frequency resource determined based on the virtual cell ID information.

According to the present invention, a conflict of resources used for hybrid Automatic Repeat ReQuest (ARQ) information transmitted in a downlink in a wireless communication system may be prevented.

### BRIEF DESCRIPTION OF THE DRAWINGS

FIG. 1 illustrates a wireless communication system according to embodiments of the present invention.

FIG. 2 is a diagram illustrating a PHICH processing process in a Transmission Point (TP);

FIG. 3 illustrates a system in which a single macro evolved Node B (eNB) and one or more RRHs cooperate for communication, the macro eNB and the one or more RRHs use an identical cell ID, and hybrid ARQ information is transmitted through a PHICH;

FIG. 4 illustrates an HARQ information transmitting method in the system of FIG. 3;

FIG. 5 is a diagram illustrating E-PHICH mapping;

FIG. 6 illustrates a system in which a single macro eNB and one or more RRHs cooperate for communication, the macro eNB and the one or more RRHs use an identical cell ID, and hybrid ARQ information is transmitted through an E-PHICH; and

FIG. 7 illustrates an HARQ information transmitting method in the system of FIG. 6.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

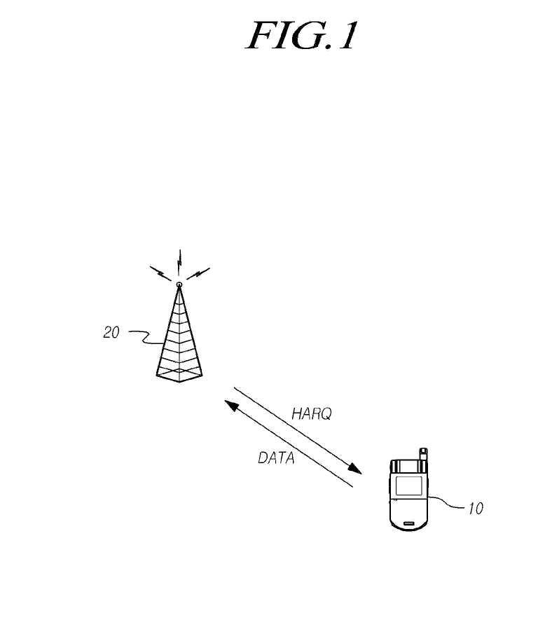

FIG. 1 illustrates a wireless communication system according to embodiments of the present invention.

The wireless communication system may be widely installed so as to provide various communication services, such as a voice service, packet data, and the like.

Referring to FIG. 1, the wireless communication system may include a User Equipment (UE) 10 and a Transmission Point (TP) 20 that executes uplink and downlink communication with the UE 10.

The UE 10 may transmit, to the TP 20, uplink data through a Physical Uplink Shared Channel (PUSCH), and the TP 20 may transmit an HARQ response with respect to the uplink data transmission of the UE 10 through a Physical HARQ Indicator Channel (PHICH).

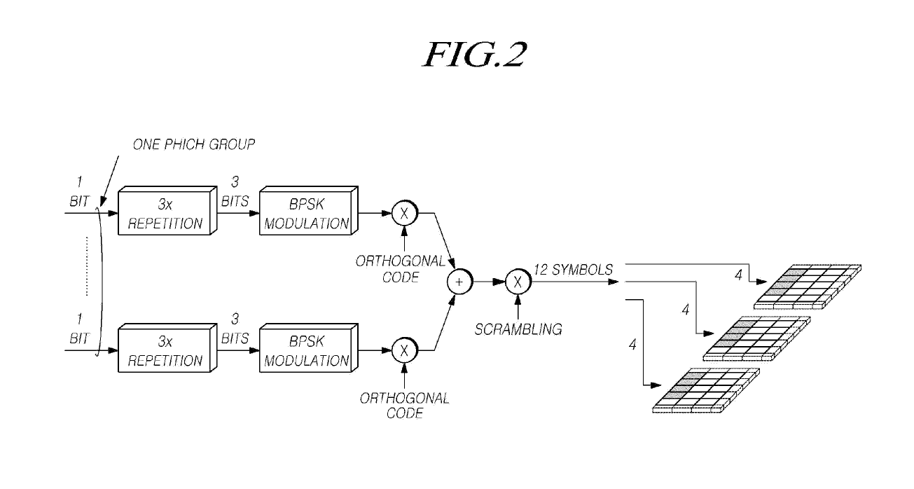

FIG. 2 is a diagram illustrating a PHICH processing process in the TP 20.

Referring to FIG. 2, 1 bit information of an HARQ A/N is repeated (repetition) three times, is BiPhase Shift Keying (BPSK) modulated based on an I axis or Q axis, and is spread as an orthogonal sequence having a length of 4 or 2. PHICHs that are transmitted in an identical set of Resource Elements (REs) are referred to as a PHICH group or a PHICH mapping unit. In a case of a normal Cyclic Prefix (CP), 4 orthogonal sequences are used and 8 PHICHs form a single PHICH group. In a case of an extended CP, 2 orthogonal sequences are used and 4 PHICHs form a single PHICH group.

PHICHs are configured to be in a complex form in a single PHICH group, and the signal is scrambled and then scrambled symbols are mapped to three REGs. Each REG is formed of 4 REs. To obtain an excellent frequency diversity gain, each REG is located, being is spaced apart at intervals of ⅓ of a downlink cell bandwidth.

A PHICH is transmitted in 1 through 3 Orthogonal Frequency Division Multiplexing (OFDM) symbols. When a PHICH is transmitted in a single OFDM symbol, three REGs to which a PHICH is mapped are located in a single OFDM. When a PHICH is transmitted in two OFDM symbols, two REGs are located in a single OFDM symbol, and a single REG is located in the other OFDM symbol. When a PHICH is transmitted in three OFDM symbols, a single REG is located in each OFDM symbol.

A PHICH may be set in a control area formed of 1 through 4 OFDM symbols in a single subframe. The control area may include control channels, such as a Physical Control Format Indicator Channel (PCFICH), a Physical Downlink Control Channel (PDCCH), and the like, in addition to the PHICH. A resource for a PCFICH is allocated from a resource of a control area, and subsequently, a resource for a PHICH is allocated. Therefore, an amount of frequency resources for a PHICH may be different for each OFDM symbol.

For example, when each REG for a PHICH is located, being spaced apart at intervals of ⅓ of a downlink cell bandwidth, an offset of an REG may be determined based on a cell ID.

Accordingly, mapping of an REG for a PHICH in a frequency domain may be based on the following Equation 1.

$${\overline{n}}_{i} = \{ \begin{matrix}( ⌊ {N}_{ID}^{cell} \cdot {n}_{{l}_{i}^{′}} / {n}_{1} ⌋ + {m}^{′} ) mod {n}_{{l}_{i}^{′}} & i = 0 \\ ( ⌊ {N}_{ID}^{cell} \cdot {n}_{{l}_{i}^{′}} / {n}_{1} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{cell} \cdot {n}_{{l}_{i}^{′}} / {n}_{1} ⌋ + {m}^{′} + ⌊ 2 {n}_{{l}_{i}^{′}} / 3 ⌋ ) mod {n}_{{l}_{i}^{′}} & i = 2\end{matrix} , \\ or \\ {\overline{n}}_{i} = \{ \begin{matrix}( ⌊ {N}_{ID}^{cell} \cdot {n}_{{l}_{i}^{′}} / {n}_{0} ⌋ + {m}^{′} ) mod {n}_{{l}_{i}^{′}} & i = 0 \\ ( ⌊ {N}_{ID}^{cell} \cdot {n}_{{l}_{i}^{′}} / {n}_{0} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{cell} \cdot {n}_{{l}_{i}^{′}} / {n}_{0} ⌋ + {m}^{′} + ⌊ 2 {n}_{{l}_{i}^{′}} / 3 ⌋ ) mod {n}_{{l}_{i}^{′}} & i = 2\end{matrix} \qquad [ Equation 1 ]$$

In Equation 1, n̅ᵢ denotes an index of a REG in which a PHICH is transmitted, N_{ID}^{cell} denotes a cell ID, m′ denotes an index of a PHICH group, and n_{l′}_{ᵢ} denotes the number of REGs available for PHICH transmission in an OFDM symbol l′ᵢ. n_{l′}_{ᵢ}/n₁ or n_{l′}_{ᵢ}/n₀ may be used for adjusting the number of available REGs since the number of available REGs is different for each OFDM symbol. For example, a resource for a Physical Control Format Indicator Channel (PCFICH) is allocated to a first OFDM symbol and thus, the number of available REGs may be different from other OFDM symbols. A first equation of Equation 1 may be applied to a case of an extended PHICH duration of a Multicast/Broadcast over a Single Frequency Network (MBSFN) subframe or an extended PHICH duration of subframes 1 and 6 of a frame structure 2, and a second equation may be applied to the rest. According to Equation 1, each REG for a PHICH is located by being spaced apart at intervals of ⅓ of a downlink cell bandwidth, and the offset may be determined based on a cell ID.

A PHICH resource may be identified by the following Equation 2.

n_{PHICH}^{group}=(I_{PRB}_{_{—}}_{RA}+n_{DMRS})mod N_{PHICH}^{group}+I_{PHICH}N_{PHICH}^{group}

n_{PHICH}^{seq}=(└I_{PRB}_{_{—}}_{RA}/N_{PHICH}^{group}┘+n_{DMRS})mod 2N_{SF}^{PHICH} [Equation 2]

In Equation 2, a PHICH group number n_{PHICH}^{group} indicates a PHICH group in which a PHICH for a UE is included, and an orthogonal sequence index n_{PHICH}^{seq} is indicates an index of the PHICH for the UE in the PHICH group. The PHICH group number n_{PHICH}^{group} may be a value identical to an index m′ of the PHICH group of Equation 1. I_{PRB}_{_{—}}_{RA} denotes an index of the lowest Physical Resource Block (PRB) for transmission of a PUSCH corresponding to a PHICH, n_{DMRS} denotes a Cyclic Shift (CS) value for Demodulation Reference Signal (DM-RS), N_{PHICH}^{group} denotes the number of PHICH groups, I_{PHICH} denotes a value of 1 in a case of PUSCH transmission in subframe n=4 or n=9 in Time Division Duplex (TDD) UL/EL configuration 0 and denotes a value of 0 for the rest, and n_{SF}^{PHICH} denotes a spreading factor used for PHICH modulation, and has a value of 4 in the case of the normal CP and has a value of 2 in the case of the extended CP.

Referring to Equation 2, the PHICH group number n_{PHICH}^{group} and the orthogonal sequence index n_{PHICH}^{seq} are determined based on the index I_{PRB}_{_{—}}_{RA} of the lowest PRB for PUSCH transmission and the value of the CS for the DM-RS.

Meanwhile, when a plurality of TPs cooperate for communication, a PHICH resource conflict may occur.

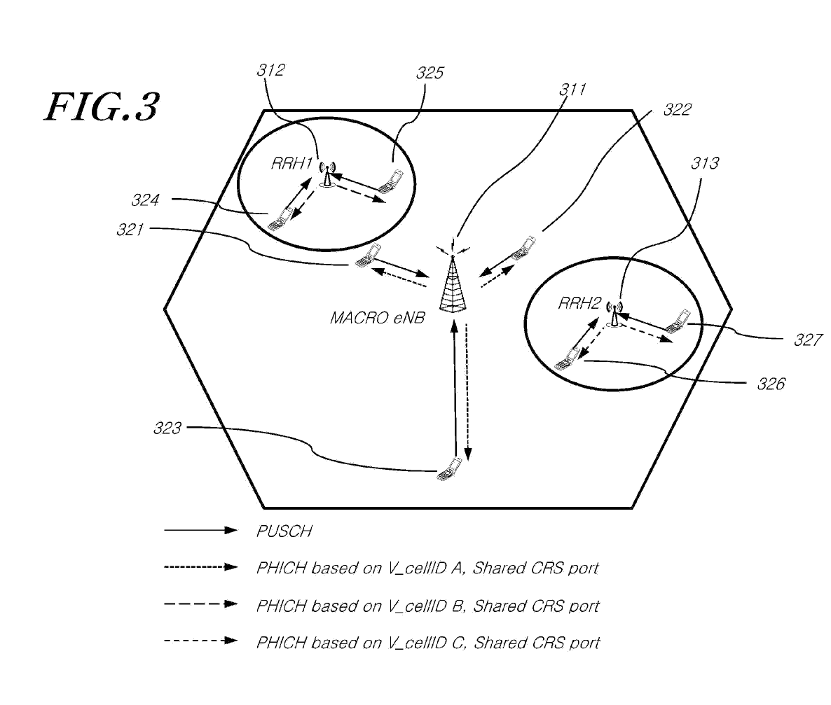

FIG. 3 illustrates a case in which a single macro evolved Node B (eNB) 311 and one or more RRHs 312 and 313 cooperate for communication, and the macro eNB 311 and the one or more RRHs 312 and 131 use an identical cell ID. Each of a plurality of UEs 321 through 327 may communicate with a single TP or with a plurality of TPs. In FIG. 3, the UE1 321 is through the UE3 323 transmit uplink data to the macro eNB 311 through a PUSCH, the UE4 324 and the UE5 325 transmit uplink data to the RRH1 312 through a PUSCH, and the UE6 326 and the UE7 327 transmit uplink data to the RRH2 313 through a PUSCH. The macro eNB 311 and the RRHs 312 and 313 transmit, to the UEs 321 through 327 through a PHICH, an HARQ A/N corresponding to the PUSCH that each UE transmits.

To effectively use an electromagnetic wave resource, it is considered that UEs that communicate with different TPs execute communication using identical time-frequency resources. In FIG. 3, the UE1 321 that communicates with the macro eNB 311 and the UE4 324 that communicates with the RRH1 312 may execute PUSCH transmission using identical time-frequency resources, through use of different UL DMRS resources.

However, when the UE1 321 and the UE4 324 even have an identical CS value of group the DM-RS, PHICH group numbers n_{PHICH}^{group} and orthogonal sequence indices n_{PHICH}^{seq} for the UE1 321 and the UE4 324 may be identical, with reference to Equation 2. In this instance, PUSCH resources for the UE1 321 and the UE4 324 may not conflict but PHICH resources for the UE1 321 and the UE4 324 may conflict.

The above problem may become worse when a plurality of uplink Semi-Persistent Scheduling (SPS) UEs exist. As a condition for triggering uplink SPS transmission, a CS of a DM-RS may be set to ‘000’. When the plurality of SPS UEs use an identical resource block, a PHICH resource conflict may occur.

According to an embodiment of the present invention, a different virtual cell ID is is set for each TP and a PHICH resource may be allocated based on the virtual cell ID.

In FIG. 3, a virtual cell ID A is applied to a PHICH transmitted from the macro eNB 311, a virtual cell ID B is applied to a PHICH transmitted from the RRH1 312, and a virtual cell ID C is applied to a PHICH transmitted from the RRH2 313. Here, transmission of a PHICH indicates transmission of an A/N through a channel named PHICH, and applying a virtual cell ID to a PHICH indicates determination of an index of an REG on a frequency domain using the virtual cell ID.

One of the virtual cell IDs may be identical to a cell ID. For example, the virtual cell ID A applied to the PHICH transmitted from the macro eNB 311 may be a value identical to the cell ID.

When the number of UEs that communicate with a predetermined TP is relatively smaller than a reference number set in advance, or smaller than the number of UEs that communicate with another TP, it is possible that an identical virtual cell ID is applied to resources of PHICHs transmitted from a plurality of TPs. For example, when the number of UEs that communicate with the RRH1 312 and the number of UEs that communicate with the RRH2 313 are smaller than the number of UEs that communicate with the macro eNB 311, a virtual cell ID applied to a PHICH resource configuration of a PHICH transmitted from the RRH1 312 and a virtual cell ID applied to a PHICH resource configuration of a PHICH transmitted from the RRH2 313 may be identical, which are different from a virtual cell ID applied to a PHICH resource configuration of a PHICH transmitted from the macro eNB 311.

In this instance, mapping of an REG for a PHICH in a frequency domain may be based on the following Equation 3.

$${\overline{n}}_{i} = \{ \begin{matrix}( ⌊ {N}_{ID}^{Virtual cell} \cdot {n}_{{l}_{i}^{′}} / {n}_{1} ⌋ + {m}^{′} ) mod {n}_{{l}_{i}^{′}} & i = 0 \\ ( ⌊ {N}_{ID}^{Virtual cell} \cdot {n}_{{l}_{i}^{′}} / {n}_{1} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{Virtual cell} \cdot {n}_{{l}_{i}^{′}} / {n}_{1} ⌋ + {m}^{′} + ⌊ 2 {n}_{{l}_{i}^{′}} / 3 ⌋ ) mod {n}_{{l}_{i}^{′}} & i = 2\end{matrix} , \\ or \\ {\overline{n}}_{i} = \{ \begin{matrix}( ⌊ {N}_{ID}^{Virtual cell} \cdot {n}_{{l}_{i}^{′}} / {n}_{0} ⌋ + {m}^{′} ) mod {n}_{{l}_{i}^{′}} & i = 0 \\ ( ⌊ {N}_{ID}^{Virtual cell} \cdot {n}_{{l}_{i}^{′}} / {n}_{0} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{Virtual cell} \cdot {n}_{{l}_{i}^{′}} / {n}_{0} ⌋ + {m}^{′} + ⌊ 2 {n}_{{l}_{i}^{′}} / 3 ⌋ ) mod {n}_{{l}_{i}^{′}} & i = 2\end{matrix} \qquad [ Equation 3 ]$$

In Equation 3, n̅ᵢ denotes an index of an REG in which a PHICH is transmitted, N_{ID}^{Virtual cell} denotes a virtual cell ID, m′ denotes an index of a PHICH group, n_{l′}_{ᵢ} denotes the number of REGs available for PHICH transmission in an OFDM symbol l′ᵢ, and n_{l′}_{ᵢ}/n₁ or n_{l′}_{ᵢ}/n₀ are used for adjusting the number of available REGs since the number n_{l′}_{ᵢ} of available REGs is different for each OFDM symbol. A first equation of Equation 3 may be applied to a case of an extended PHICH duration of a Multicast/Broadcast over a Single Frequency Network (MBSFN) subframe or an extended PHICH duration of subframes 1 and 6 of a frame structure 2, and a second equation may be applied to the rest. According to Equation 3, each REG for a PHICH is located by being spaced apart at intervals of ⅓ of a downlink cell bandwidth, and the offset may be determined based on a cell ID.

According to Equation 3, a different virtual cell ID N_{ID}^{Virtual cell} may be set for each TP that executes communication, and accordingly, when an identical PHICH group index m′ is used, an index of REG in which a PHICH is transmitted may be different. Accordingly, UEs that communicate with different TPs may avoid a PHICH resource conflict.

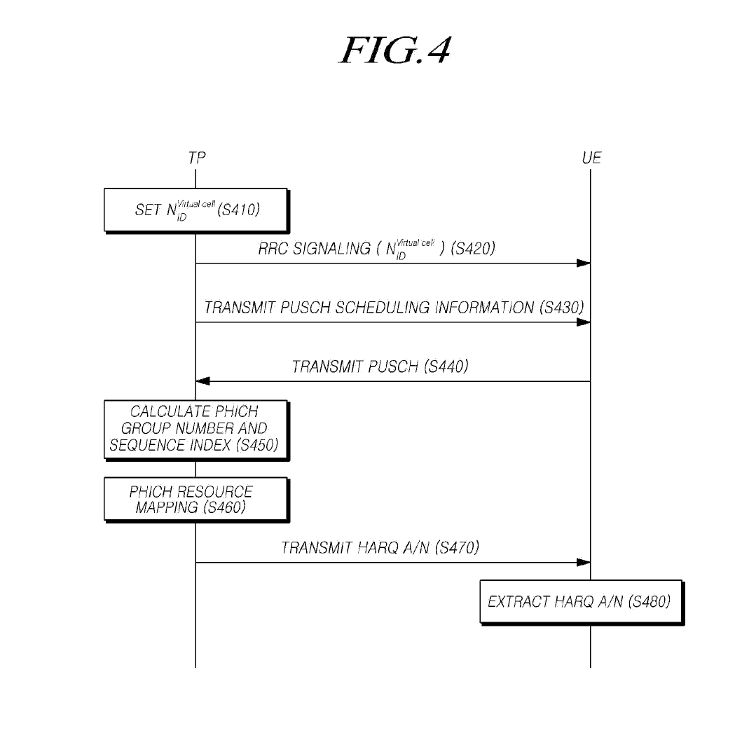

FIG. 4 illustrates an HARQ information transmitting method according to an embodiment of the present invention.

Referring to FIG. 4, a TP (for example, eNB) may set a virtual cell ID N_{ID}^{Virtual cell} as a parameter related to a PHICH, in operation S410. The virtual cell ID may be set based on a TP unit (for example, eNB and RRH).

A TP may transmit the set virtual cell ID N_{ID}^{Virtual cell} to a UE, through a higher layer signaling such as a Radio Resource Control (RRC), in operation S420.

The TP transmits uplink scheduling information for PUSCH transmission through a Physical Downlink Control Channel (PDCCH) or an E-PDCCH, in operation S430. The uplink scheduling information may include information associated with a resource block to which a PUSCH is allocated, information associated with a CS of a DM-RS, and the like.

The UE may transmit uplink data through a PUSCH, based on the received uplink scheduling information, in operation S440.

Based on Equation 2, the TP calculates a PHICH group number n_{PHICH}^{group} and an orthogonal sequence index n_{PHICH}^{seq}, based on an index I_{PRB}_{_{—}}_{RA} of the lowest PRB for PUSCH transmission and a CS value n_{DMRS} for a DM-RS, based on Equation 2, in operation S450. Also, the TP maps a PHICH resource, which is expressed by an REG index n̅ᵢ based on the virtual cell ID N_{ID}^{Virtual cell}, using Equation 3, in operation S460.

The TP transmits an HARQ A/N (that is, HARQ information or HARQ A/N information) through the PHICH resource mapped in operation S460, in operation S470.

The UE receives the HARQ A/N transmitted from the TP, in operation S480. In particular, the UE extracts information associated with a physical resource to which a PHICH is allocated using Equation 3, and identifies a PHICH resource for the UE using Equation 2.

The above described embodiment describes a PHICH located in a control area. Meanwhile, in addition to the PHICH allocated to the control area, a new channel for transmission of a HARQ A/N may be required, for the reasons below.

(1) A carrier that does not have a control area, or a carrier that does not have a CRS, may be considered in a downlink. That is, there may be a case in which allocation of a PHICH is difficult.

(2) Decoding a HARQ ACK/NACK may be required using a reference signal which is different from a CRS, to improve a transmission environment using beamforming, Spatial Multiplexing (SM), and frequency domain Inter Cell Interference Coordination (ICIC).

(3) When a plurality of TPs have an identical cell ID and cooperate for communication, as described in Coordinated Multi-Point (CoMP) scenario 4, the limited PHICH resource may act as bottleneck when the plurality of TPs cooperate for communication and may limit the cooperative communication.

(4) In a case of uplink SPS, the probability of a PHICH resource conflict may increase. To avoid the above, additional UL grant scheduling limitations may be caused.

Due to the above described reasons, a resource for transmitting control information may be allocated to a data area, as opposed to a control area, and a channel for HARQ transmission with respect to uplink transmission corresponding to a PHICH and/or a channel for transmission of downlink control information corresponding to a PDCCH may be set in the resource.

In the present specification, a channel allocated to the data area for transmitting the control information is referred to as an Enhanced Control CHannel or an Extended Control Channel (E-CCH), a channel corresponding to a PHICH in the E-CCH is referred to as an Enhanced PHICH or an Extended PHICH (E-PHICH), and a channel corresponding to a PDCCH is referred to as an Enhanced PDCCH or an Extended PDCCH (E-PDCCH). Alternatively, it is mainly used as a downlink control channel corresponding to a PDCCH and thus, the channel allocated to the data area for transmitting the control information may be referred to as an E-PDCCH. The above described names are for ease of description, and the present invention is not limited to the described names. The E-PHICH and the E-PDCCH are decoded using a downlink DM-RS.

A minimum mapping unit for mapping an E-PHICH may be an Enhance REG (EREG). In the same manner as the PHICH, a single EREG is formed of four REs. However, the present invention may not be limited thereto, and an EREG (or a minimum mapping unit) differently defined may be used.

The number of available REGs (or REs) that may be used in an E-CCH may be affected by various overhead configurations. Here, the overhead configurations that may be considered herein may include an existing control area, a Channel Status Information Reference signal (CSI-RS) configuration, zero-power CSI-RS configuration, a DM-RS configuration, a CRS configuration, and the like.

In an example, the E-CCH may be set in a Resource Block Pair (RBP) set in advance, and a resource for an E-PHICH may be set in a predetermined OFDM symbol from among resources for the E-PCCH.

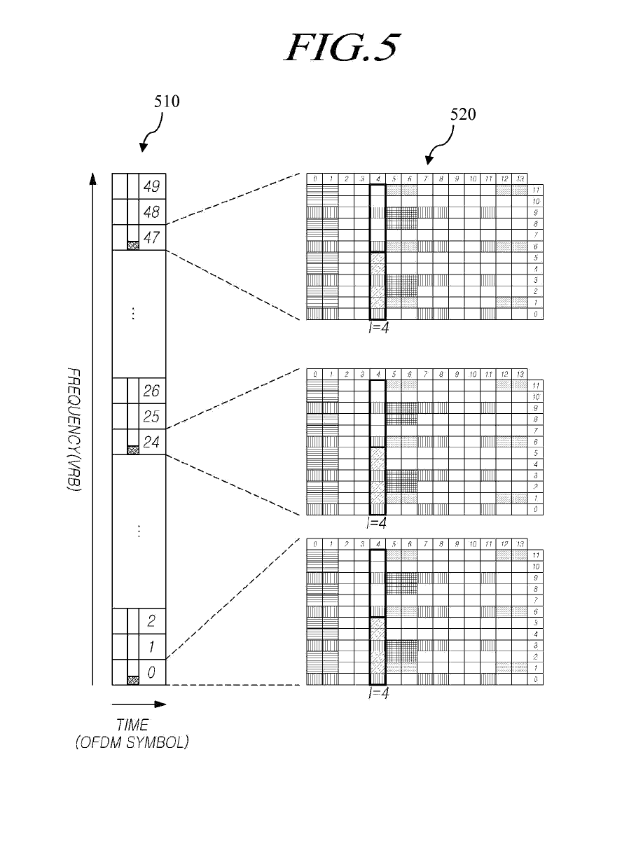

FIG. 5 is a diagram illustrating E-PHICH mapping. The diagram “510” of FIG. 5 illustrates an entire band, and the diagram “520” illustrates a magnified RBP. An area to which a control area, a CRS (or a reduced CRS which may be used in an NCT), a DM-RS, a CSI-RS, and the like are allocated in the RBP 520, is illustrated.

Referring to FIG. 5, nine resource blocks (resource block indices 0, 1, 2, 24, 25, 26, 47, 48, and 49) from among a total of 50 resource blocks (resource block indices 0 through 49) may be provided for the E-CCH. A fifth OFDM symbol (1=4) in the nine resource blocks to which the E-CCH is allocated, is set to be a resource for an E-PHICH. In a single resource block, four resource elements are allocated for a CRS in the fifth OFDM symbol. Therefore, eight resource elements from among the twelve resource elements located in the fifth OFDM symbol may be set to be the resource for the E-PHICH. A single REG is formed of four resource elements. Accordingly, in the example of FIG. 5, two REGs may be located in a single resource block and a total of 18 (=9×2) REGs may be used for E-PHICH transmission.

The E-PHICH may be mapped to three REGs. Referring to FIG. 5, the E-PHICH may be mapped to three REGs out of the 18 REGs.

In this instance, mapping of an REG for an E-PHICH in a frequency domain may be based on the following Equation 4.

$${\overline{n}}_{i} = \{ \begin{matrix}( ⌊ {N}_{ID}^{Virtual cell} \cdot {n}_{{l}_{i}^{′}} / {n}_{{l}_{0 i}^{′}} ⌋ + {m}^{′} ) mod {n}_{{l}_{i}^{′}} & i = 0 \\ ( ⌊ {N}_{ID}^{Virtual cell} \cdot {n}_{{l}_{i}^{′}} / {n}_{{l}_{0 i}^{′}} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{Virtual cell} \cdot {n}_{{l}_{i}^{′}} / {n}_{{l}_{0 i}^{′}} ⌋ + {m}^{′} + ⌊ 2 {n}_{{l}_{i}^{′}} / 3 ⌋ ) mod {n}_{{l}_{i}^{′}} & i = 2\end{matrix} \qquad [ Equation 4 ]$$

In Equation 4, n̅ᵢ denotes an index of each REG through which an E-PHICH is transmitted and may have a value of 0 through 17 in the case of FIG. 5. n_{l′}_{ᵢ} denotes the number of REGs that may be considered for E-PHICH transmission in an OFDM symbol l′ᵢ, and the value in the fifth OFDM symbol may be 18 in the case of FIG. 5. A physical resource area of an E-PHICH may be a physical resource area set through an RRC, instead of an entire system band. Accordingly, the value of n_{l′}_{ᵢ} may be affected by a physical frequency (physical resource block set by an RRC) and a time (OFDM symbol), allocated for E-PHICH transmission. n_{l′}_{ᵢ}/n_{l′}_{₀ᵢ} is a factor obtained by considering E-PHICH transmission occurring in a plurality of OFDM symbols. m′ denotes an index of an E-PHICH group.

In Equation 4, N_{ID}^{Virtual cell} denotes a virtual cell ID. The virtual cell ID may be set to be different for each TP, in a system in which a plurality of TPs has an identical cell ID.

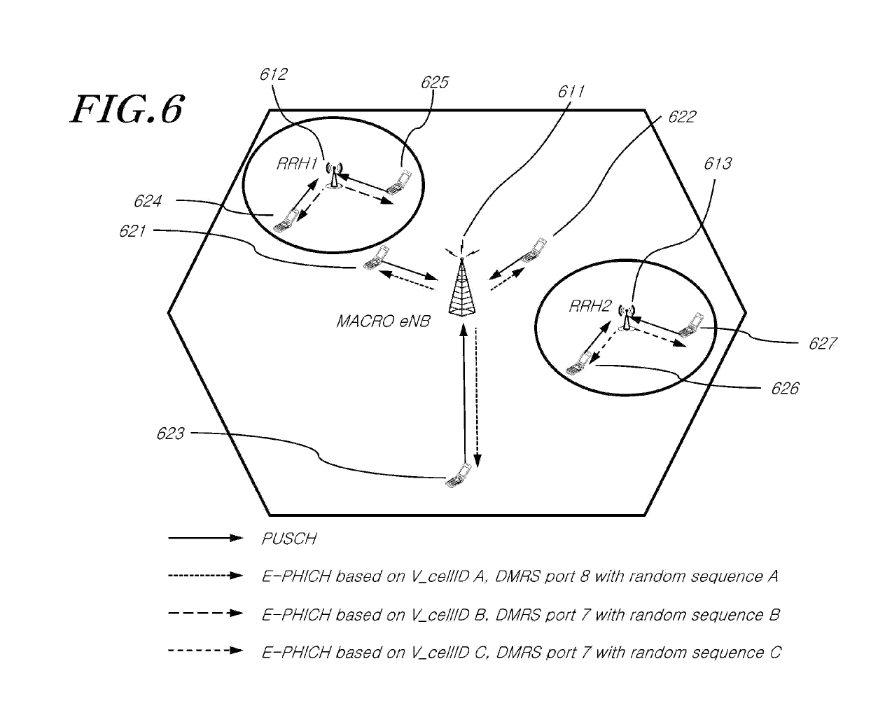

FIG. 6 illustrates a case in which a single macro eNB 611 and one or more RRHs 612 and 613 cooperate for communication, and the macro eNB 611 and the one or more RRHs 612 and 613 use an identical cell ID. Each of a plurality of UEs 621 through 627 may communicate with a single TP or with a plurality of TPs. In FIG. 6, the UE1 621 through the UE3 623 transmit uplink data to the macro eNB 611 through a PUSCH, the UE4 624 and the UE5 625 transmit uplink data to the RRH1 612 through a PUSCH, and the UE6 626 and the UE7 627 transmit uplink data to the RRH2 613 through a PUSCH.

The macro eNB 611 and the RRHs 612 and 613 transmit, to the UEs 621 through is 627 through an E-PHICH, an HARQ A/N corresponding to the PUSCH that each UE transmits. In this instance, a resource of an E-PHICH that each TP 611 through 613 transmits to a corresponding UE 621 through 627 is determined based on a virtual cell ID, and the virtual cell ID is determined based on the TP 621 through 627.

For example, the macro eNB 611 sets an E-PHICH resource based on a virtual cell ID A in association with the UE1 621 through UE3 623, and a DM-RS for E-PHICH demodulation may use a random sequence A and a DM-RS port 8. The RRH1 612 sets an E-PHICH resource based on a virtual cell ID B in association with the UE4 624 and UE5 625, and a DM-RS for E-PHICH demodulation may use a random sequence B and a DM-RS port 7. The RRH2 613 sets an E-PHICH resource based on a virtual cell ID C in association with the UE6 626 and UE7 627, and a DM-RS for E-PHICH demodulation may use a random sequence C and a DM-RS port 7.

As described in FIG. 6, when a different virtual cell ID is set for each TP 611 through 613, each E-PHICH may be allocated to different resources in a frequency axis based on the different virtual cell IDs irrespective of which of the scrambling sequences is used in an identical port, and thus, an E-PHICH transmitted from each TP 611 through 614 may have complete orthogonality. That is, based on Equation 4, each TP 611 through 613 has different virtual cell IDs and thus, transmission may be executed with different offsets in physical frequency resources.

In FIG. 6, to reduce interference affected, by E-PHICH transmission from the macro eNB 611, to transmission from RRHs 612 and 613, a DM-RS related to an E-PHICH is transmitted from the macro eNB 611 may be transmitted on a DM-RS port which is different from a DM-RS related to an E-PHICH transmitted from the RRHs 612 and 613.

In FIG. 6, a virtual cell ID is separately set for each TP 611 through 613. In another embodiment, a virtual cell ID A is set for the macro eNB 611, and an identical virtual cell ID B is set for the RRHs 612 and 613. The macro eNB 611 and the RRHs 612 and 613 have different virtual cell IDs and thus, may provide complete orthogonality, having different frequency offsets. Also, the RRH1 612 and the RRH2 613 have the identical virtual cell ID but may have orthogonality by using different DM-RS random sequences.

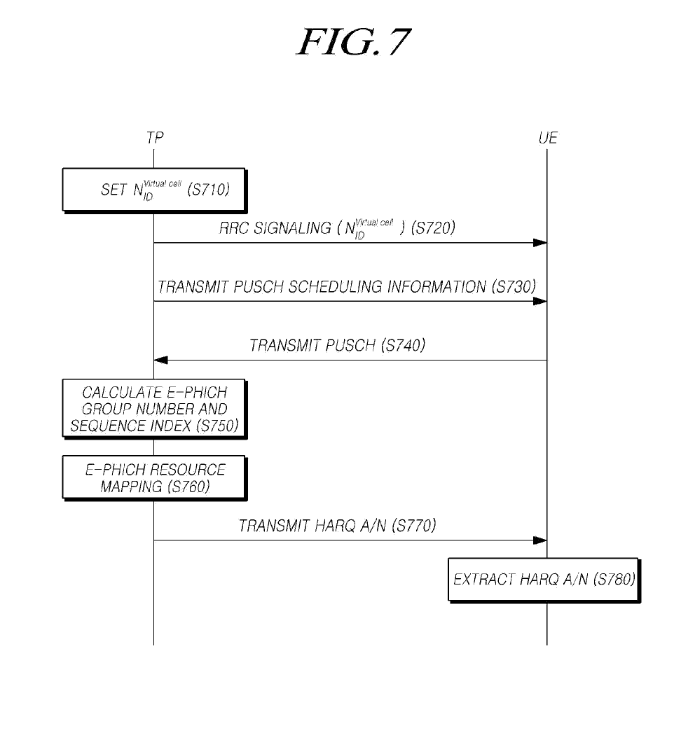

FIG. 7 illustrates an HARQ information transmitting method according to an embodiment of the present invention.

Referring to FIG. 7, a TP (for example, eNB) sets a virtual cell ID N_{ID}^{Virtual cell} as a parameter related to an E-PHICH, in operation S710. The virtual cell ID may be set based on a TP unit (for example, eNB and RRH).

A TP may transmit the set virtual cell ID N_{ID}^{Virtual cell} to a UE, through a higher layer signaling such as a Radio Resource Control (RRC), in operation S720.

The TP transmits uplink scheduling information for PUSCH transmission through a Physical Downlink Control Channel (PDCCH) or an E-PDCCH, in operation S730. The uplink scheduling information may include information associated with a resource block to which a PUSCH is allocated, information associated with a CS of a DM-RS, and the like.

The UE may transmit uplink data through a PUSCH, based on the received uplink scheduling information, in operation S740.

Based on Equation 2, the TP calculates a PHICH group number n_{PHICH}^{group} seq and an orthogonal sequence index n_{PHICH}^{seq}, based on an index I_{PRB}_{_{—}}_{RA} of the lowest PRB is for PUSCH transmission and a CS value n_{DMRS} for a DM-RS, based on Equation 2, in operation S750. Also, the TP maps an E-PHICH resource, which is expressed by an REG index n̅ᵢ based on the virtual cell ID N_{ID}^{Virtual cell}, using Equation 4, in operation S760.

The TP transmits an HARQ A/N (that is, HARQ information or HARQ A/N information) through the E-PHICH resource mapped in operation S760, in operation S770.

The UE receives the HARQ A/N transmitted from the TP, in operation S780. In particular, the UE extracts information associated with a physical resource to which an E-PHICH is allocated using Equation 4, and identifies an E-PHICH resource for the UE using Equation 2.

Although the embodiments of the present invention have been described for illustrative purposes, those skilled in the art will appreciate that various modifications, additions and substitutions are possible, without departing from the scope and spirit of the invention. Accordingly, the embodiments disclosed in the present invention are only for describing, but not limiting, the technical idea of the present invention, and the scope of the technical idea of the present invention is not limited by the embodiments. The scope of the present invention shall be construed on the basis of the accompanying claims in such a manner that all of the technical ideas included within the scope equivalent to the claims belong to the present invention.

1. A method for a Transmission Point (TP) to transmit hybrid Automatic Repeat reQuest (ARQ) information, in a system including a plurality of TPs, the method comprising:
transmitting virtual cell Identity (ID) information to a User Equipment (UE); and
transmitting hybrid ARQ information indicating whether uplink data transmitted from the UE is received, using a frequency resource determined based on the virtual cell ID information.

2. The method as claimed in claim 1, wherein the virtual cell ID information is transmitted through a Radio Resource Control (RRC).

3. The method as claimed in claim 1, wherein the hybrid ARQ information is transmitted through a Physical HARQ Indication Channel (PHICH) set in a downlink control area.

4. The method as claimed in claim 3, wherein a frequency resource of the PHICH is determined based on the following equation:
$${\overline{n}}_{i} = \{ \begin{matrix}( ⌊ {N}_{ID}^{Virtual cell} \cdot {n}_{{l}_{i}^{′}} / {n}_{1} ⌋ + {m}^{′} ) mod {n}_{{l}_{i}^{′}} & i = 0 \\ ( ⌊ {N}_{ID}^{Virtual cell} \cdot {n}_{{l}_{i}^{′}} / {n}_{1} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{Virtual cell} \cdot {n}_{{l}_{i}^{′}} / {n}_{1} ⌋ + {m}^{′} + ⌊ 2 {n}_{{l}_{i}^{′}} / 3 ⌋ ) mod {n}_{{l}_{i}^{′}} & i = 2\end{matrix} , \\ or \\ {\overline{n}}_{i} = \{ \begin{matrix}( ⌊ {N}_{ID}^{Virtual cell} \cdot {n}_{{l}_{i}^{′}} / {n}_{0} ⌋ + {m}^{′} ) mod {n}_{{l}_{i}^{′}} & i = 0 \\ ( ⌊ {N}_{ID}^{Virtual cell} \cdot {n}_{{l}_{i}^{′}} / {n}_{0} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{Virtual cell} \cdot {n}_{{l}_{i}^{′}} / {n}_{0} ⌋ + {m}^{′} + ⌊ 2 {n}_{{l}_{i}^{′}} / 3 ⌋ ) mod {n}_{{l}_{i}^{′}} & i = 2\end{matrix} ,$$
wherein n̅ᵢ denotes an index of a Resource Element Group (REG) in which the PHICH is transmitted, N_{ID}^{Virtual cell} denotes a virtual cell ID, m′ denotes an index of a PHICH group, n_{l′}_{ᵢ} denotes the number of REGs available for PHICH transmission in an Orthogonal Frequency Division Multiplexing (OFDM) symbol l′ᵢ, and a first equation is applied to a case of an extended PHICH duration of a Multicast/Broadcast over a Single Frequency Network (MBSFN) subframe or an extended PHICH duration of subframes 1 and 6 of a frame structure 2, and a second equation is applied to the rest.

5. The method as claimed in claim 1, wherein the hybrid ARQ information is transmitted through an Enhanced Physical HARQ Indication Channel (E-PHICH) set in a downlink data area.

6. The method as claimed in claim 5, wherein a frequency resource of the E-PHICH is determined based on the following equation:
$${\overline{n}}_{i} = \{ \begin{matrix}( ⌊ {N}_{ID}^{Virtual cell} \cdot {n}_{{l}_{i}^{′}} / {n}_{{l}_{0 i}^{′}} ⌋ + {m}^{′} ) mod {n}_{{l}_{i}^{′}} & i = 0 \\ ( ⌊ {N}_{ID}^{Virtual cell} \cdot {n}_{{l}_{i}^{′}} / {n}_{{l}_{0 i}^{′}} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{Virtual cell} \cdot {n}_{{l}_{i}^{′}} / {n}_{{l}_{0 i}^{′}} ⌋ + {m}^{′} + ⌊ 2 {n}_{{l}_{i}^{′}} / 3 ⌋ ) mod {n}_{{l}_{i}^{′}} & i = 2\end{matrix} ,$$
wherein n̅ᵢ denotes an index of a Resource Element Group (REG) in which the E-PHICH is transmitted, N_{ID}^{Virtual cell} denotes a virtual cell ID, m′ denotes an index of an E-PHICH group, and n_{l′}_{ᵢ} denotes the number of REGs available for E-PHICH transmission in an Orthogonal Frequency Division Multiplexing (OFDM) symbol l′ᵢ.

7. A method for a User Equipment (UE) to receive hybrid Automatic Repeat reQuest (ARQ) information, in a system including a plurality of Transmission Points (TPs), the method comprising:
receiving virtual cell Identity (ID) information from a TP;
transmitting uplink data; and
receiving hybrid ARQ information indicating whether the TP receives the uplink data transmitted from the UE, using a frequency resource determined based on the virtual cell ID information.

8. The method as claimed in claim 7, wherein the virtual cell ID information is received through a Radio Resource Control (RRC).

9. The method as claimed in claim 7, wherein the hybrid ARQ information is received through a Physical HARQ Indication Channel (PHICH) set in a downlink control area.

10. The method as claimed in claim 9, wherein a frequency resource of the PHICH is determined based on the following equation:
$${\overline{n}}_{i} = \{ \begin{matrix}( ⌊ {N}_{ID}^{Virtual cell} \cdot {n}_{{l}_{i}^{′}} / {n}_{1} ⌋ + {m}^{′} ) mod {n}_{{l}_{i}^{′}} & i = 0 \\ ( ⌊ {N}_{ID}^{Virtual cell} \cdot {n}_{{l}_{i}^{′}} / {n}_{1} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{Virtual cell} \cdot {n}_{{l}_{i}^{′}} / {n}_{1} ⌋ + {m}^{′} + ⌊ 2 {n}_{{l}_{i}^{′}} / 3 ⌋ ) mod {n}_{{l}_{i}^{′}} & i = 2\end{matrix} , \\ or \\ {\overline{n}}_{i} = \{ \begin{matrix}( ⌊ {N}_{ID}^{Virtual cell} \cdot {n}_{{l}_{i}^{′}} / {n}_{0} ⌋ + {m}^{′} ) mod {n}_{{l}_{i}^{′}} & i = 0 \\ ( ⌊ {N}_{ID}^{Virtual cell} \cdot {n}_{{l}_{i}^{′}} / {n}_{0} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{Virtual cell} \cdot {n}_{{l}_{i}^{′}} / {n}_{0} ⌋ + {m}^{′} + ⌊ 2 {n}_{{l}_{i}^{′}} / 3 ⌋ ) mod {n}_{{l}_{i}^{′}} & i = 2\end{matrix} ,$$
wherein n̅ᵢ denotes an index of a Resource Element Group (REG) in which the PHICH is transmitted, N_{ID}^{Virtual cell} denotes a virtual cell ID, m′ denotes an index of a PHICH group, n_{l′}_{ᵢ} denotes the number of REGs available for PHICH transmission in an Orthogonal Frequency Division Multiplexing (OFDM) symbol l′ᵢ, and a first equation is applied to a case of an extended PHICH duration of a Multicast/Broadcast over a Single Frequency Network (MBSFN) subframe or an extended PHICH duration of subframes 1 and 6 of a frame structure 2, and a second equation is applied to the rest.

11. The method as claimed in claim 7, wherein the hybrid ARQ information is transmitted through an Enhanced Physical HARQ Indication Channel (E-PHICH) set in a downlink data area.

12. The method as claimed in claim 11, wherein a frequency resource of the E-PHICH is determined based on the following equation:
$${\overline{n}}_{i} = \{ \begin{matrix}( ⌊ {N}_{ID}^{Virtual cell} \cdot {n}_{{l}_{i}^{′}} / {n}_{{l}_{0 i}^{′}} ⌋ + {m}^{′} ) mod {n}_{{l}_{i}^{′}} & i = 0 \\ ( ⌊ {N}_{ID}^{Virtual cell} \cdot {n}_{{l}_{i}^{′}} / {n}_{{l}_{0 i}^{′}} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{Virtual cell} \cdot {n}_{{l}_{i}^{′}} / {n}_{{l}_{0 i}^{′}} ⌋ + {m}^{′} + ⌊ 2 {n}_{{l}_{i}^{′}} / 3 ⌋ ) mod {n}_{{l}_{i}^{′}} & i = 2\end{matrix} ,$$
wherein n̅ᵢ denotes an index of a Resource Element Group (REG) in which the E-PHICH is transmitted, N_{ID}^{Virtual cell} denotes a virtual cell ID, m′ denotes an index of an E-PHICH group, and n_{l′}_{ᵢ} denotes the number of REGs available for E-PHICH transmission in an Orthogonal Frequency Division Multiplexing (OFDM) symbol l′ᵢ.
